(19) United States
(12) Patent Application Publication
(10) Pub. No.: US 2016/0270370 A1
(43) Pub. Date: Sep. 22, 2016

(54) BUTTERFLY GLOBE PET TOY

(71) Applicant: Worldwise, Inc., San Rafael, CA (US)

(72) Inventors: Charles Floyd, Oakland, CA (US); Sara Paculdo, Novato, CA (US); Andrew Murrer, Alamo, CA (US)

(21) Appl. No.: 14/660,686

(22) Filed: Mar. 17, 2015

(51) Int. Cl. A01K 15/02; H02K 7/14; H02P 3/18; A01K 29/00

(52) U.S. Cl. CPC A01K 15/025; A01K 29/00; H02K 7/14; H02P 3/18

(57) ABSTRACT

A pet toy having a transparent housing in the form of a sphere. Within the housing is a fan assembly fixed to its interior surface which includes a mass that orients the sphere as having a top and bottom, the fan assembly residing at the bottom. The fan assembly also includes a power source, a motor energized by the power source having a shaft extending vertically therefrom, and a plurality of fan blades that are fixed to the shaft such that upon rotation, the fan blades direct air toward the bottom of the sphere. The sphere is also provided with an opening in the transparent housing located at its top and a plurality of attractants each of a mass and size to randomly circulate within the transparent housing upon energizing the motor.

### TECHNICAL FIELD

The present invention is directed to a pet toy specifically intended to captivate and intrigue cats. Activation of this device causes attractants to vigorously move within a transparent globe enabling a cat to swipe at them within the globe and to pounce upon those attractants which randomly escape its confines.

### BACKGROUND OF THE INVENTION

Although it is commonplace to leave cats alone within one's home for extended periods of time, they can oftentimes become bored resulting in potentially destructive behavior. Cats also have the instinctive need to swipe and pounce on prey and many pet toys intended to be used by cat owners rely upon this inherent behavioral characteristic by causing an attractant to move hoping that a cat will become engaged thus satisfying its need to swat and pounce upon prey and to alleviate boredom. However, many of such devices are complex and move an attractant in a predetermined consistent fashion. In doing so, a cat will, although initially intrigued, eventually become bored as the motion of the attractant becomes constant and predictable.

It is thus an object to the present invention to provide a pet toy which is relatively simple to fabricate and robust in its ability to withstand engagement by an aggressive cat.

It is yet a further object of the present invention to provide a pet toy which presents to an engaged cat an attractant which is caused to move in an unpredictable and haphazard fashion thus maintaining a cat's interest for relatively prolonged periods of time.

These and further objects will be readily apparent when considering the following disclosure and appended claims.

### SUMMARY OF THE INVENTION

The present invention is directed to a pet toy in the form of a substantially transparent spherical housing. A fan assembly is fixed to an interior surface of the housing, said fan assembly comprising a mass that orients said sphere as having a top and a bottom, said fan assembly residing at said bottom. The fan assembly further comprises a power source, a motor energized by the power source having a shaft extending vertically there from, a plurality of fan blades that are a fixed to said shaft such that upon rotation, the fan blades direct air toward the bottom, said sphere also having an opening in the substantially transparent housing located at its top and a plurality of attractants each of a mass and size as to randomly circulate within said substantially transparent housing upon energizing the motor.

### BRIEF DESCRIPTION OF THE FIGURES

FIG. 1 is a perspective view of the pet toy of the present invention.

FIG. 2 is a schematic view of the fan assembly of the pet toy of the present invention.

FIG. 3 is a top view of the pet toy of the present invention.

FIG. 4 is a side view of the pet toy of the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

Turning to FIG. 1, pet toy 10 is shown having substantially transparent housing 11. Substantially transparent housing 11 is preferably fabricated of plastic and should be sufficiently transparent such that a cat sitting next to and gazing into it would see the ongoing activity (to be described hereinafter) and be somewhat mesmerized by it. Ideally, substantially transparent housing 11 is further characterized as having relatively flat bottom 64 residing upon support 5 to help to maintain the orientation of toy 10 as depicted in the various figures appended hereto. To further assist in maintaining the proper orientation of the toy, weight 29 can be contained within fan assembly 12. Thus, pet toy 10 is provided with a top 2 and a bottom 3 and motor 19 oriented vertically such that rotatable motor shaft 25 also extends vertically towards top 2.

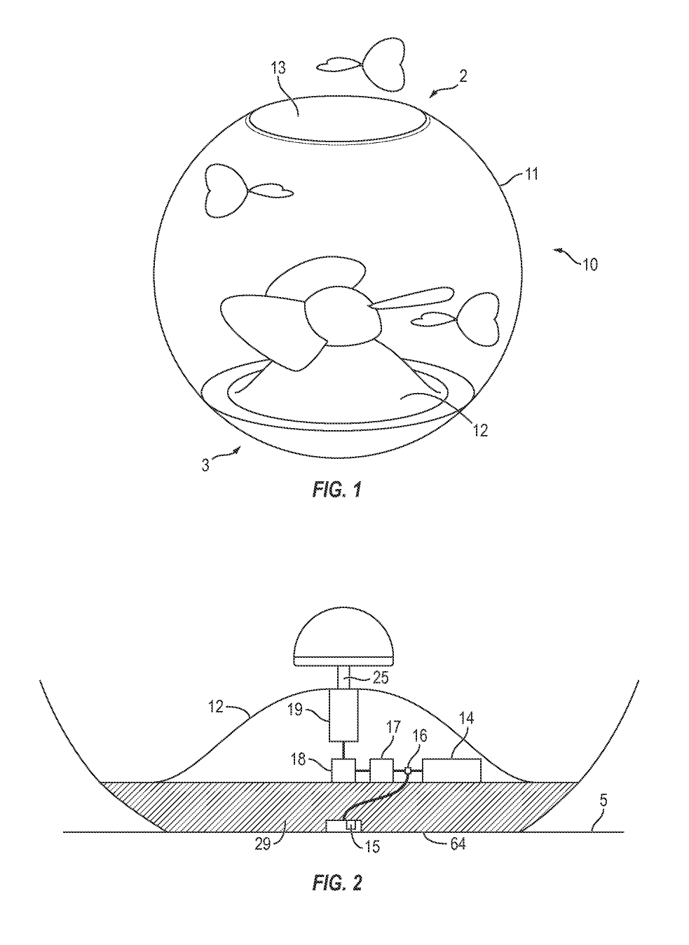

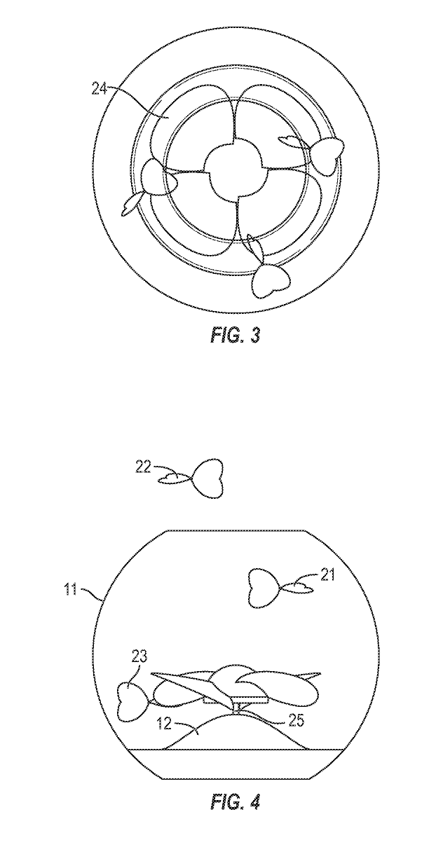

Fan assembly 12, best depicted schematically in FIG. 2, includes power supply 14, timer 17, integrated circuit 18 and motor 19. Power source 14 can be in the form of replaceable or rechargeable batteries or, alternatively, a suitable AC adapter can be employed for connecting pet toy 10 to an AC outlet thus obviating the need for a self-contained battery pack.

Pet toy 10 can be activated by switch 15 accessible by a user on the outer surface of pet toy 10, ideally at or about bottom region 3 which in turn activates control 16. To enable a pet owner to simply activate pet toy 10 and allow his or her pet to use it without supervision, as a preferred embodiment, timer 17 is included which will interrupt power to motor 19 after the passage of a predetermined period of time. To also increase the attention grabbing and maintaining attributes of pet toy 10, integrated circuit 18 can be included to vary the speed of motor 19 and thus the speed of fan 45 encouraging the random movement of attractants 21, 22 and 23.

Fan 45 is fixed to motor shaft 25 and is rotated such that blades 24, ideally in the shape of flower petals, cause air within substantially transparent housing 11 to move downwardly. This causes air movement within substantially transparent housing 11 to suspend attractants 21, 22 and 23 and cause them to move like butterflies within the interior of substantially transparent housing 11. Further, substantially transparent housing 11 is provided with opening 13 which serves several purposes. First, opening 13 enables air to recirculate as fan 45 draws air into and pushes air out of substantially transparent housing 11. Second, fan 45 causes attractants 21, 22 and 23 to vigorously and haphazardly move within substantially transparent housing 11 such that, occasionally, one or more of the attractants escape there through encouraging the vigilant cat to pounce on it thinking that it is live prey. This again enhances the mesmerizing effect of toy 10 to a greater extent than similar toys currently available. Third, opening 13 is large enough to enable a cat to attempt to reach within the interior of substantially transparent housing 11 in its attempt to prey upon the attractants.

Attractants 21, 22 and 23 can take on various physical characteristics without departing from the spirit and scope of the present invention. Ideally, attractants 21, 22 and 23 are light in weight composed of, for example, fabric “wings” to encourage them to remain suspended by the moving air created by fan 45 and in many ways, replicate the movement of a fluttering butterfly. Cats find such movement totally engaging and can be transfixed by the movement of attractants 21, 22 and 23 for surprisingly long periods of time.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A pet toy comprising a substantially transparent housing substantially in the form of a sphere, a fan assembly fixed to an interior surface of said housing, said fan assembly comprising a mass that orients said sphere as having a top and a bottom, said fan assembly residing at said bottom, said fan assembly further comprising a power source, a motor energized by said power source having a shaft extending vertically there from, a plurality of fan blades fixed to said shaft such that upon rotation, said fan blades direct air toward said bottom, said sphere also having an opening in said substantially transparent housing located at said top and a plurality of attractants each of a mass and size as to randomly circulate within said substantially transparent housing upon energizing said motor.

2. The pet toy of claim 1 further comprising a timer for stopping power to said motor after passage of a period of time.

3. The pet toy of claim 1 further comprising an integrated circuit for varying the speed of said motor shaft.

4. The pet toy of claim 1 wherein said sphere is characterized as having a flat surface at said bottom for maintaining its orientation.

5. The pet toy of claim 1 wherein the combination of said fan speed, mass of said attractants and size of said opening promotes the random escape of attractants through said opening.

6. The pet toy of claim 1 wherein said fan blades are shaped like flower petals.

7. The pet toy of claim 1 further comprising a weighted mass located within said fan assembly for maintaining the orientation of said sphere.
